(19) United States
(12) Patent Application Publication
(10) Pub. No.: US 2004/0022213 A1
(43) Pub. Date: Feb. 5, 2004

(54) Apparatus and method for determining CQI report cycle in an HSDPA communication system

(75) Inventors: Sung-Ho Choi, Suwon-shi (KR); Soeng-Hun Kim, Suwon-shi (KR); Ju-Ho Lee, Suwon-shi (KR); Joon-Goo Park, Seoul (KR); Young-Ju Im, Songnam-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/452,165

(22) Filed: Jun. 2, 2003

(30) Foreign Application Priority Data
May 31, 2002 (KR) 30735/2002

(51) Int. Cl. H04Q 7/00

(52) U.S. Cl. 370/332; 370/253

(57) ABSTRACT

An apparatus for determining channel quality indicator (CQI) report cycles for user equipments (UEs), upon receiving CQI information from the UEs receiving a high speed downlink packet access (HSDPA) service from a Node B, in a mobile communication system including the Node B, a plurality of the UEs existing in a cell region occupied by the Node B, a controlling radio network controller (CRNC) connected to the Node B, and a serving radio network controller (SRNC) connected to the CRNC. The Node B determines recommended CQI report cycles based on the number of UEs and the CQI information, and transmits the determined recommended CQI report cycles to the SRNC via the CRNC. The SRNC determines CQI report cycles for the UEs referring to the recommended CQI report cycles, and transmits the determined CQI report cycles to the UEs and the Node B.

### PRIORITY

This application claims priority under 35 U.S.C. § 119 to an application entitled “Apparatus and Method for Determining CQI Report Cycle in an HSDPA communication system” filed in the Korean Intellectual Property Office on May 31, 2002 and assigned Serial No. 2002-30735, the contents of which are incorporated herein by reference.

### BACKGROUND OF THE INVENTION

1. Field of the Invention

The present invention relates generally to a communication system using a high speed downlink packet access (HSDPA) scheme (hereinafter referred to as an “HSDPA communication system”), and in particular, to an apparatus and method for determining a report cycle for which a user equipment (UE) reports downlink channel quality to a Node B.

2. Description of the Related Art

Generally, HSDPA refers to a data transmission scheme including a high speed downlink shared channel (HS-DSCH), which is a downlink data channel for supporting high speed downlink packet data transmission, and it's associated control channels in a UMTS (Universal Mobile Telecommunications System) communication system. Adaptive modulation and coding (AMC) scheme, hybrid automatic retransmission request (HARQ) scheme, and fast cell select (FCS) scheme have been proposed to support HSDPA.

AMC scheme refers to a data transmission scheme for adaptively determining a modulation scheme and a coding scheme according to a channel condition between a particular Node B and a UE, thereby improving overall utilization efficiency of the Node B. Therefore, AMC scheme has a plurality of modulation schemes and coding schemes, and modulates and codes a data channel signal by combining the modulation schemes and coding schemes. Commonly, each combination of the modulation schemes and the coding schemes is referred to as “modulation and coding scheme (MCS)”, and a plurality of MCSs of a level #1 to a level #n can be defined according to the number of the MCSs. That is, AMC scheme is a technique for improving overall system efficiency of a Node B by adaptively determining an MCS level according to a channel condition between a UE and a Node B that are wirelessly connected to the UE.

In n-channel stop and wait hybrid automatic retransmission request (n-channel SAW HARQ) scheme, typical HARQ scheme, the following two proposals have been provided in order to increase transmission efficiency of automatic retransmission request (ARQ) scheme. As a first proposal, HARQ scheme exchanges retransmission requests and responses between a UE and a Node B. As a second proposal, HARQ scheme temporarily stores defective data and then combines the defective data with its retransmitted data. In order to make up for the defects of conventional stop and wait automatic retransmission request (SAW ARQ) scheme, HADPA has introduced n-channel SAW HARQ scheme. In SAW ARQ scheme, next packet data is not transmitted until acknowledgement (ACK) information for previous packet data is received. Therefore, in some cases, a UE or a Node B must wait for ACK information even though it can currently transmit packet data. However, in n-channel SAW HARQ scheme, a UE or a Node B can continuously transmit packet data even before ACK information for previous packet data is received, thereby increasing channel efficiency. That is, n logical channels are set up between a UE and a Node B. If the n logical channels can be identified by time or a channel number, a UE receiving packet data can determine a logical channel over which the packet data is received. In addition, the UE can reconfigure the packet data in the right order or soft-combine the corresponding packet data.

In FCS scheme, if a UE supporting HSDPA is located in a cell overlapping region or a soft handover region, a cell having the best channel condition is selected from a plurality of cells. Specifically, if a UE supporting HSDPA enters a cell overlapping region between an old Node B and a new Node B, the UE sets up radio links to a plurality of cells, or Node Bs. A set of the cells to which the UE sets up radio links is referred to as an “active set.” The UE receives HSDPA packet data only from a cell having the best channel condition among the cells included in the active set, thereby reducing overall interference. Herein, the cell having the best channel condition will be referred to as a “best cell.” For this, the UE must periodically monitor channel conditions of the cells included in the active set, thereby determining whether there is a cell having a better channel condition than the current best cell. If there is any cell having a better channel condition, the UE transmits a best cell indicator to the cells belonging to the active set in order to replace the current best cell with the new best cell. The best cell indicator includes an identifier of the new best cell. Each cell in the active set receives the best cell indicator and analyzes a cell identifier included in the received best cell indicator. That is, each cell in the active set determines whether a cell identifier included in the best cell indicator is identical to its own cell identifier. If the cell identifiers are identical to each other, the corresponding cell selected as a new best cell transmits packet data to the UE over the HS-DSCH.

A description will now be made of a channel quality indicator (CQI), typical control information used in an HSDPA communication system.

Upon receiving a downlink channel signal, a UE must measure channel quality (CQ) of the received downlink channel signal, and report the measured channel quality to a Node B. The Node B then receives the channel quality information from the UE, determines an MCS level of an HS-DSCH over which data is actually transmitted to the UE according to the received channel quality information, and creates transport format and resource related information (TFRI), i.e., HS-DSCH control information. For example, if the channel quality information received from the UE indicates a good channel condition, the Node B can select a modulation scheme of 16-QAM (16-ary Quadrature Amplitude Modulation) which can increase a data rate at the sacrifice of a bit error rate (BER). In contrast, if the received channel quality information indicates a poor channel condition, the Node B can select a modulation scheme of QPSK (Quadrature Phase Shift Keying) to increase BER performance.

A description will now be made of how a UE creates CQI according to the quality of a downlink channel signal.

The CQI is used by a Node B in determining an MCS level of an HS-DSCH. If a downlink channel is in good condition, the Node B selects a high MCS level having a high data rate. In contrast, if the downlink channel is in poor condition, the Node B selects a low MCS level having a low data rate. The Node B then transmits the HSDSCH using the selected MCS level. Commonly, channel quality can be determined through a carrier-to-interference ratio (C/I) measurement value of a common pilot channel (CPICH). However, when a UE transmits only the channel condition information to the Node B, variety of UEs is not guaranteed. That is, even in the same channel condition, a UE having higher performance can support a higher MCS level than a UE having lower performance. However, the Node B, because it cannot know performance of the UE, will select an available MCS level on the basis of a UE having normal performance. Therefore, it is preferable that the UE should generate CQI considering its performance.

As described above, the Node B determines an MCS level of an HS-DSCH by receiving the CQI from the UE. If the Node B unilaterally determines the MCS level of the HS-DSCH, it is not possible to consider a variety of UEs. In order to determine an MCS level considering a variety of UEs, the UEs must provide information so that their performance should be considered. That is, the UE monitors a current channel condition by measuring C/I from a CPICH, and determines a maximum available transport format and resource combination (TFRC) as CQI according to the monitored channel condition, considering its performance. The information included in the TFRC is a modulation scheme of the HS-DSCH, a transport block set (TBS), and the number of available HS-DSCHs. If TFRC in which performance of the UE is considered is received from the UE, the Node B determines TFRI according to the received TFRC. The TFRI is an MCS level to be used in the HS-DSCH, HS-DSCH channelization code information, and transport format. That is, the UE reports its maximum capacity to the Node B using the TFRC, and the Node B determines TFRI based on its capacity and the TFRC reported by the UE.

In order to maintain an optimal channel condition between a Node B and a UE, the Node B receives CQI for a dedicated channel from the UE. Because the CQI is transmitted through physical layer signaling, both the Node B and the UE must know a plurality of setting conditions such as a report cycle for CQI reporting and a transmission time offset. That is, both the Node B and the UE must know the CQI report cycle in order to transmit and receive a CQI report. Herein, the CQI report cycle is defined as “k value.” For example, if a particular UE in a Node B desires to perform handover, information related to the handover is transmitted to a radio network controller (RNC), and the RNC transmits the handover-related information of the particular UE to the Node B, using an NBAP (Node B Application Part) message. The NBAP message indicates a message exchanged between an RNC and a Node B. The Node B then determines whether the UE desiring to perform the handover is in a normal state or a handover state, and determines a k value, i.e., a CQI report cycle, according to the determination result.

As stated above, a Node B receives CQI in order to acquire correct information on a channel condition between itself and a UE. Information on the channel condition between the Node B and the UE can become not only CQI received from the UE but also transmission power for a downlink dedicated physical channel (DL_DPCH), which is being power-controlled between the UE and the Node B. However, information on the transmission power of the DL_DPCH may not correctly reflect a channel condition of the UE when the UE is in a handover state. Therefore, CQI received from the UE is indispensable in order to accurately analyze a channel situation of the UE. Thus, the CQI must be provided more frequently when the UE is in a handover state rather than when the UE is in a non-handover state, in order to accurately determine a channel condition of the UE.

Therefore, a k value, or a report cycle for which the CQI is reported, is variably controlled according to a channel condition of the UE. Herein, the k value can have a value of 0, 1, 2, 4, 8, 16, 32,, n. If the k value is 0, it means that no CQI report is made, and if the k value is 1, it means that CQI report is performed every TTI (Transmit Time Interval), or every 3 time slots. As described above, the UE can report CQI every k TTIs. Since the CQI, as stated above, is transmitted through physical layer signaling, both the Node B and the UE must set the k value, a report cycle for CQI reporting, to the same value, in order to perform accurate CQI report.

The k value is differently determined according to a state of a UE, i.e., according to whether the UE is in a handover state or a non-handover state. Also, the k value is differently determined according to a change in the channel condition of the UE. In addition, when the k value is small, a UE frequently performs a CQI report. CQI reports from a plurality of UEs may act as uplink interference, so the number of UEs existing in the same cell should be considered when determining the k value. Because information used when determining the k value is recognized by (or known to) different entities, for example, a serving radio network controller (SRNC), a controlling radio network controller (CRNC), or a Node B, there is a demand for a method of determining the k value by gathering together the information used when determining the k value. Also, there is a demand for a method of appropriately determining the k value so that a decision by each Node B for the k value should be reflected.

### SUMMARY OF THE INVENTION

It is, therefore, an object of the present invention to provide an apparatus and method for determining a CQI report cycle for downlink CQI reporting in an HSDPA communication system.

It is another object of the present invention to provide an apparatus and method for determining an optimal CQI report cycle for downlink CQI reporting based on information identified by each communication identity providing an HSDPA service to a UE in an HSDPA communication system.

It is further another object of the present invention to provide an apparatus and method for determining a CQI report cycle for downlink CQI reporting by considering a radio channel environment in an HSDPA communication system.

To achieve the above and other objects, there is provided an apparatus for determining channel quality indicator (CQI) report cycles for user equipments (UEs) upon receiving CQI information from the UEs receiving a high speed downlink packet access (HSDPA) service from a Node B, in a mobile communication system including the Node B, a plurality of the UEs existing in a cell region occupied by the Node B, a controlling radio network controller (CRNC) connected to the Node B, and a serving radio network controller (SRNC) connected to the CRNC. The Node B determines recommended CQI report cycles based on the number of UEs and the CQI information, and transmits the determined recommended CQI report cycles to the SRNC via the CRNC. The SRNC determines CQI report cycles for the UEs referring to the recommended CQI report cycles, and transmits the determined CQI report cycles to the UEs and the Node B.

To achieve the above and other objects, there is provided a method for determining channel quality indicator (CQI) report cycles for user equipments (UEs) upon receiving CQI information from the UEs receiving a high speed downlink packet access (HSDPA) service from a Node B, in a mobile communication system including the Node B, a plurality of the UEs existing in a cell region occupied by the Node B, a controlling radio network controller (CRNC) connected to the Node B, and a serving radio network controller (SRNC) connected to the CRNC. The method comprising the steps of determining, by the Node B, recommended CQI report cycles based on the number of UEs and the CQI information; transmitting, by the Node B, the recommended CQI report cycles to the SRNC via the CRNC; and transmitting, by the SRNC, the CQI report cycles determined for the recommended CQI report cycles to the UEs and the Node B.

### BRIEF DESCRIPTION OF THE DRAWINGS

The above and other objects, features, and advantages of the present invention will become more apparent from the following detailed description when taken in conjunction with the accompanying drawings in which:

FIG. 1 schematically illustrates a structure of a wideband code division multiple access mobile communication system;

FIG. 2 is a flow diagram illustrating a process of determining a CQI report cycle according to a first embodiment of the present invention;

FIG. 3 is a flow diagram illustrating a process of determining a CQI report cycle according to a second embodiment of the present invention;

FIG. 4 is a flow diagram illustrating a process of determining a CQI report cycle according to a third embodiment of the present invention;

FIG. 5 is a flow diagram illustrating a process of determining a CQI report cycle according to a fourth embodiment of the present invention;

FIG. 6 is a flow diagram illustrating a process of determining a CQI report cycle according to a fifth embodiment of the present invention;

FIG. 7 is a flow diagram illustrating a process of determining a CQI report cycle according to a sixth embodiment of the present invention;

FIG. 8 is a block diagram illustrating an internal structure of a Node B apparatus for determining a recommended CQI report cycle according to ACK/NACK;

FIG. 9 is a block diagram illustrating an internal structure of a Node B apparatus for determining a recommended CQI report cycle according to a channel condition variation rate; and

FIG. 10 is a block diagram illustrating an internal structure of a UE for performing a CQI report according to the embodiments of the present invention.

### DETAILED DESCRIPTION OF THE PREFERRED EMBODIMENT

Several preferred embodiments of the present invention will now be described in detail herein below with reference to the annexed drawings. In the drawings, the same or similar elements are denoted by the same reference numerals even though they are depicted in different drawings. In the following description, a detailed description of known functions and configurations incorporated herein has been omitted for conciseness.

The present invention proposes a method for determining a k value, or a Channel Quality Indicator (CQI) report cycle, and transmitting and receiving the determined k value in an High Speed Downlink Packet Access (HSDPA) communication system.

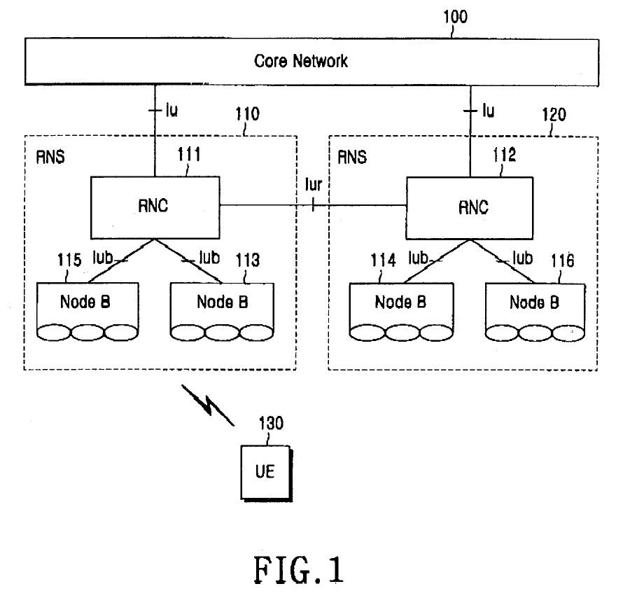

FIG. 1 schematically illustrates a structure of a wideband code division multiple access (W-CDMA) mobile communication system. Referring to FIG. 1, the WCDMA mobile communication system includes a core network (CN) 100, a plurality of radio network subsystems (RNSs) 110 and 120, and a user equipment (UE) 130. Each of the RNSs 110 and 120 includes a radio network controller (RNC) and a plurality of Node Bs. For example, the RNS 110 includes an RNC 111 and Node Bs 113 and 115, and the RNS 120 includes an RNC 112 and Node Bs 114 and 116. The RNC is classified into a serving RNC (SRNC), a drift RNC (DRNC), and a controlling RNC CRNC) according to its operation. The SRNC is an RNC that manages information on each UE and controls data communication with the CN 100. When data from a UE is transmitted to an SRNC via a particular RNC rather than the SRNC, the particular RNC becomes an DRNC. The CRNC is an RNC that controls each Node B. In FIG. 1, if information from the UE 130 is managed by the RNC 111, the RNC 111 serves as an SRNC for the UE 130, and if data from the UE 130 is received via the RNC 112 due to movement of the UE 130, the RNC 112 becomes a DRNC for the UE 130, and the RNC 111 that controls the Node B 113 in communication with the UE 130 becomes a CRNC for the Node B 113.

Information necessary for determining a k value includes:

(info #1) handover state information of a UE,

(info #2) channel condition change information of a UE,

(info #3) information on UEs reporting CQI in the same cell, and

(info #4) state information of neighbor cells.

A detailed description of the above information will be made herein below.

First, the “(info #1) handover state information of a UE” represents the number of radio links of a UE, and is recognized by the SRNC. When the UE is in a non-handover state, the UE sets up one radio link with only a Node B currently in service. In contrast, the UE is in a handover state, the UE sets up radio links to multiple Node Bs existing in an active set. That is, if the number of radio links set up by the UE is 1, it indicates that the UE is in a non-handover state, and if the number of radio links set up by the UE is 2 or more, it indicates that the UE is in a handover state.

Second, the “(info #2) channel condition change information of a ULE” represents a change in the condition of a downlink channel received by a corresponding UE, and can be determined through various measurement reports that a Node B receives from the UE.

Third, the “(info #3) information on UEs reporting CQI in the same cell” is recognized by a CRNC or a Node B, and represents the number of UEs receiving an HSDPA service in the same cell and a k value, or a CQI report cycle, for each UE.

Fourth, the “(info #4) state information of neighbor cells” is information on neighbor cells to which the UE will report the CQI, and includes information on the number of UEs existing in the neighbor cells, the number of UEs reporting the CQI in the neighbor cells, and a k value (CQI report cycle) of each UE. The “(info #4) state information of neighbor cells” can be recognized by the CRNC.

The present invention proposes at least six embodiments for determining a k value, or a CQI report cycle, by the CRNC, and recommending the CRNC the k value by the Node B and the SRNC based on information that can be recognized by Node Bs.

A brief description will now be made of six embodiments of the present invention.

(1) In a first embodiment, an SRNC preferentially determines a recommended k value using a Radio Link Setup process and transmits the determined recommended k value to an CRNC. The CRNC then determines the k value based on the recommended k value received from the SRNC and delivers the determined k value to a Node B and a UE.

(2) In a second embodiment, an SRNC, when it desires to change a previously determined k value, sends a corresponding report to a CRNC using a Radio Link Reconfiguration process. The CRNC then determines a k value according to the received report and delivers the determined k value to a Node B and a UE.

(3) In a third embodiment, a CRNC, when it desires to change a previously determined k value, delivers a k value determined using a Physical Channel Reconfiguration process to a Node B and a UE via an SRNC.

(4) In a fourth embodiment, a Node B, when it desires to change a previously determined k value, sends a recommended k value to a CRNC using a Physical Channel Reconfiguration Indication process. The CRNC then determines a k value based on the recommended k value received from the Node B, delivers the determined k value to the Node B, and delivers the determined k value to a UE via an SRNC.

(5) In a fifth embodiment, a Node B or a CRNC recommend a k value, and an SRNC determines a k value based on the k value recommended by the Node B or the CRNC.

(6) In a sixth embodiment, a Node B or a CRNC recommend a k value, and an SRNC determines a k value based on the k value recommended by the Node B or the CRNC and at the same time, determines an activation time.

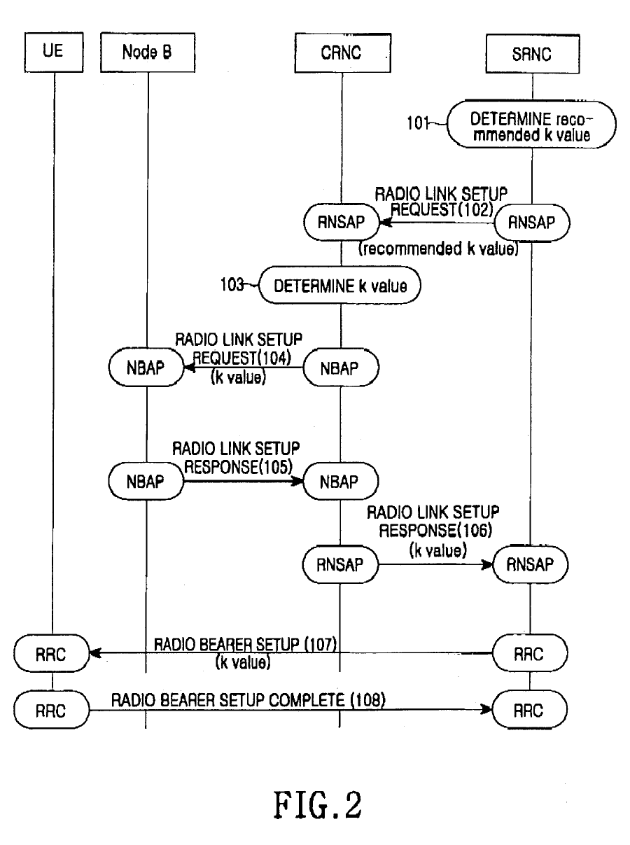

The first embodiment of the present invention will now be described with reference to FIG. 2.

FIG. 2 is a flow diagram illustrating a process of determining a CQI report cycle according to a first embodiment of the present invention. Referring to FIG. 2, an SRNC determines a k value to be recommended for a CRNC in Step 101. Herein, the k value to be recommended will be referred to as a “recommended k value” for simplicity. The SRNC determines the recommended k value according to a handover state of a UE. For example, if the number of radio links for a corresponding UE within a range of the k value is large, the SRNC sets the recommended k value to a relatively small value. In contrast, if the number of radio links is small, the SRNC sets the recommended k value to a relatively large value. That is, when the UE is in a handover sate, the SRNC sets the recommended k value to a small value so that CQI report should be performed frequently. When the UE is in a non-handover state, the SRNC sets the recommended k value to a large value to increase a CQI report cycle as compared with when the UE is in a handover state. A range of the k value can become 0, 1, 5, 10, 20, 40, and 80. If the k value is 0, it indicates that CQI report is not performed. If the k value is 1, it indicates that a CQI report cycle is 2 ms, or 3 time slots. In the HSDPA communication system, 1 Transmit Time Interval (TTI) is comprised of 3 time slots, 15 time slots constitute 1 frame, and I frame has a length of 10 ms. Therefore, a CQI report is performed every frame (10 ms) for the k value=5,, every 4 frames (40 ms) for the k value=20, every 8 frames (80 ms) for the k value=40, and every 16 frame (160 ms) for the k value=80. Although a range of the k value is set herein to 0, 1, 5, 10, 20, 40 and 80, the k value range can be changed according to circumstances.

When the SRNC determines the recommended k value considering the number of radio links set up by the UE, an example of a relationship between a range of the recommended k value and the number of radio links is illustrated in Table 1.

TABLE 1

| Number of | k value |
|---|---|
| Radio Links | range |
| 1 | 80 |
| 2 | 40 |
| 3 | 20 |
| 4 | 10 |
| 5 | 5 |
| 6 | 1 |
| 7 | 1 |
| 8 | 1 |

In Table 1, as the number of radio links becomes larger, the SRNC sets the recommended k value to a smaller value for frequent CQI report so that the UE can set up many radio links.

Another example of a relationship between the range of the recommended k value and the number of radio links is illustrated in Table 2.

TABLE 2

| Number of | k value |
|---|---|
| Radio Links | range |
| 1 | 80 |
| 2 | 1 |
| 3 | 1 |
| 4 | 1 |
| 5 | 1 |
| 6 | 1 |
| 7 | 1 |
| 8 | 1 |

In Table 2, during radio link setup, the SRNC separately determines the recommended k value when the number of radio links is two or more (the UE is in a handover state) and when the number of radio links is 1 (the UE is in a non-handover state).

After determining the recommended k value according to the handover state of the UE, the SRNC transmits the determined recommended k value to the CRNC through a radio network subsystem application part (RNSAP) message of a Radio Link Setup Request message in Step 102. The RNSAP message indicates a message exchanged between RNCs. The Radio Link Setup Request message has a format as illustrated in Table 3 below.

TABLE 3

| | | | | | | |
|---|---|---|---|---|---|---|
| | | | IE type and | Semantics | | Assigned |
| IE/Group Name | Presence | Range | reference | description | Criticality | Criticality |

| | | | | |
|---|---|---|---|---|
| HS-DSCH | | 1 . . . < | | |
| MAC-d | | max- | | |
| Flow Specific | | noof | | |
| Information | | MAC- | | |
| | | Flows> | | |
| >HS-DSCH | M | | 9.2.1.300 | |
| MAC-d Flow | | | | |
| ID | | | | |
| <Allocation/ | M | | 9.2.1.1A | |
| Retention | | | | |
| Priority | | | | |
| Recommended | M | | INTEGER | 2ms |
| CO1 Cycle k | | | (0.1.5.10.20. | |
| | | | 40.80) | |

As illustrated in Table 3, the recommended k value is included in HS-DSCH Frequency Division Duplexing (FDD) Information of the Radio Link Setup Request message. In Table 3, “Information Element (IE)/Group Name” represents the name of information to be actually transmitted in the Radio Link Setup Request message, and the recommended k value is represented by “Recommended CQI Cycle k.” In Table 3, “Presence” represents a method in which information is transmitted on the Radio Link Setup Request message, and “M (Mandatory)” represents that the information is continuously transmission. In addition, “IE type and reference” represents a range of information transmitted through the Radio Link Setup Request message, and a range of the “Recommended CQI Cycle k” value, or the recommended k value, becomes 0, 1, 5, 10, 20, 40, and 80. Further, “Semantics description” describes contents of transmission information, and 2 ms set for the Recommended CQI Cycle k indicates that a fundamental unit, i.e., k value 1, for a range of the Recommended CQI Cycle k value is 2 ms.

Upon receiving the Radio Link Setup Request message, in Step 103, the CRNC detects a recommended k value included in the Radio Link Setup Request message, and determines a k value considering the detected recommended k value, a situation of a cell to which the UE currently belongs, and a situation of neighbor cells. A process of determining the k value by the CRNC will be described herein below. The CRNC can determine a handover state of the UE, i.e., the number of radio links, using the recommended k value. If the k value is 80, the CRNC can determine that the UE is in a non-handover state, i.e., the number of radio links is 1. If the number of UEs receiving an HSDPA service in a cell where the UE belongs is defined as “M,” the number of UEs can be divided into 7 groups as illustrated in Table 4.

TABLE 4

| Group 1 | k value | Number of UEs |
|---|---|---|
| 0 | 0 | M0 |
| 1 | 1 | M1 |
| 2 | 5 | M2 |
| 3 | 10 | M3 |
| 4 | 20 | M4 |
| 5 | 40 | M5 |
| 6 | 80 | M6 |

If the number of UEs corresponding to each of the 7 groups is defined as Mi (i=0, 1, 2, 3, 4, 5, 6), an amount of uplink resource used for a current CQI report can be calculated by

Resource Amount=80*M1+16*M2+8*M3+4*M4+2*M5+1*M6 Equation (1)

The SRNC determines the recommended k value considering a maximum resource amount Max_R given to a cell, or a Node B, to which the UE belongs so that a resource amount calculated in accordance with Equation (1) should not exceed the maximum resource amount Max_R. For example, for a UE for which a k value is set to 80, if a recommended k value transmitted to the CRNC by the SRNC is 1, the resource amount is newly calculated.

If the k value is 80 (k value=80), the resource amount can be calculated by

Existing Resource Amount (k value=80)=80*M1+16*M2+8*M3+4*M4+2*M5+1*M6

After the k value is changed to 1 (k value=1), the changed resource amount becomes

Changed Resource Amount (k value=1)=80*(M1+1)+16*M2+8*M3+4*M4+2*M5+1*(M6−1)=Existing Resource Amount+79

The existing resource amount does not exceed the maximum resource amount Max_R, whereas the changed resource amount can exceed the maximum resource amount Max_R. Therefore, in this case, the CRNC determines a minimum k value not exceeding the maximum resource amount Max_R instead of the recommended k value transmitted by the SRNC.

That is, the CRNC determines the k value in accordance with Equation (2) below.

k_value=min(k value: Condition #1) Equation (2)

In Equation (2), Condition #1

$$( Existing Resource Amount ) + \frac{80}{kvalue - 1} \leq Max\_R .$$

Equation (2) above indicates that a minimum k value must be selected from the k values satisfying Condition #1. Herein, Equation (2) will be called “k value determination algorithm.” A process of determining a k value for a particular UE by a CRNC according to the first embodiment of the present invention will be summarized below.

If a recommended k value received from an SRNC is defined as k′, the k value is determined by the following algorithm.

$$if ( Existing Resource Amount ) + \frac{80}{k ' - 1} \leq Max\_R , \\ then k value = k ' else k value = min ( k\_value: Condition \# 1 )$$

Meanwhile, if a difference between the k value and the recommended k value is relatively large, the CRNC may change the k value to a small value by adjusting a k value for another UE using a small k value to a large value.

After determining the k value, the CRNC transmits the determined k value to a Node B through a Node B application part(NBAP) message of a Radio Link Setup Request message in Step 104. The NBAP message indicates a message exchanged between an RNC and a Node B. Upon receiving the Radio Link Setup Request message from the CRNC, the Node B detects a k value included in the Radio Link Setup Request message and determines the detected k value as a k value of the Node B. The k value is applied to the Node B at a time when step 104 is completed. That is, the Node B monitors a radio channel of which CQI is to be reported by a corresponding UE, according to the k value. Even though the UE is not actually transmitting CQI, the Node B performs a process of analyzing CQI. In this case, the Node B may detect wrong CQI. However, since the CQI is a value needed only when HSDPA service data is transmitted to a corresponding UE, the wrongly detected CQI may cause misoperation during actual communication.

Thereafter, the Node B transmits to the CRNC an NBAP message of a Radio Link Setup Response message indicating that a corresponding operation designated by the received Radio Link Setup Request message was performed in Step 105. Upon receiving the Radio Link Setup Response message from the Node B, the CRNC transmits the k value to the SRNC through an RNSAP message of a Radio Link Setup Response message Step 106.

Upon receiving the Radio Link Setup Response message from the CRNC, the SRNC detects a k value included in the Radio Link Setup Response message and transmits the detected k value to a UE through a radio resource control (RRC) message of a Radio Bearer Setup message in Step 107. The RRC message indicates a message exchanged between an RNC and a UE. Upon receiving the Radio Bearer Setup message from the SRNC, the UE detects a k value included in the Radio Bearer Setup message and newly determines the detected k value as a CQI report cycle. After newly setting the CQI report cycle to the detected k value, the UE transmits an RRC message of a Radio Bearer Setup Complete message to the SRNC in Step 108.

The description of FIG. 2 has been made on the assumption that RNSAP messages include a Radio Link Setup Request message and a Radio Link Setup Response message, NBAP messages include a Radio Link Setup Request message and a Radio Link Setup Response message, and RRC messages include a Radio Bearer Setup Request message and a Radio Bearer Setup Complete message. However, messages other than the above-stated messages can also be used, as long as they deliver the k value and the recommended k value.

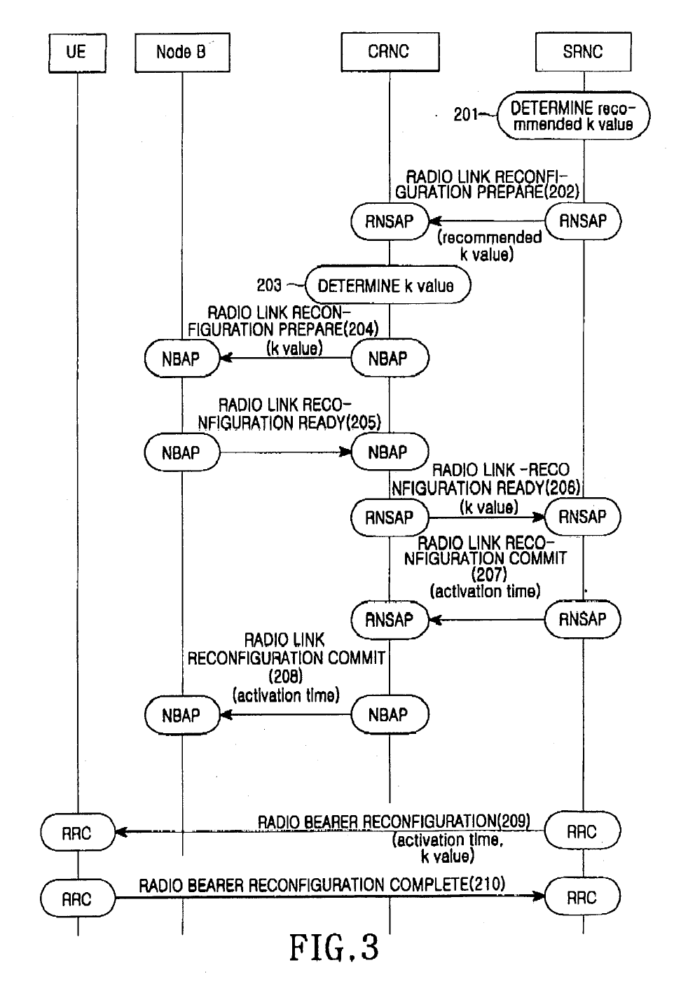

With reference to FIG. 2, a process of determining a CQI report cycle according to the first embodiment of the present invention has been described. Next, a process of determining a CQI report cycle according to a second embodiment of the present invention will be described with reference to FIG. 3.

FIG. 3 is a flow diagram illustrating a process of determining a CQI report cycle according to a second embodiment of the present invention. Referring to FIG. 3, an SRNC determines a recommended k value, or a CQI report cycle to be recommended for a CRNC in Step 201. As described in conjunction with FIG. 2, the SRNC determines the recommended k value according to a handover state of a UE. For example, if the number of radio links for a corresponding UE within a range of the k value is large, the SRNC sets the recommended k value to a relatively small value. In contrast, if the number of radio links is small, the SRNC sets the recommended k value to a relatively large value. That is, when the UE is in a handover sate, the SRNC sets the recommended k value to a small value so that CQI report should be performed frequently. When the UE is in a non-handover state, the SRNC sets the recommended k value to a large value to increase a CQI report cycle as compared with when the UE is in a handover state. In a state where a k value has already been determined as described in conjunction with FIG. 2, if the SRNC receives a measurement report for the UE at a predetermined time, a new radio link for the UE should be additionally set up. In this case, since the number of radio links set up to the UE is changed, it is necessary to change the previously determined k value. In addition, if the k value was previously set to 80, there is a necessity for the SRNC to change the k value to, for example, 1 due to an additional setup of the radio link. Therefore, the SRNC sets the recommended k value to 1. That is, in the second embodiment of the present invention, if it is necessary to change a previously determined k value, the SRNC creates a recommended k value.

The SRNC transmits the determined recommended k value to the CRNC through an RNSAP message of a Radio Link Reconfiguration Prepare message in Step 202. Herein, the recommended k value is included in a specific field of the Radio Link Reconfiguration Prepare message. For example, the recommended k value is represented by “Recommended CQI Cycle k” as described in conjunction with Table 3. Upon receiving the Radio Link Reconfiguration Prepare message from the SRNC, the CRNC detects a recommended k value included in the received Radio Link Reconfiguration Prepare message and determines a k value considering the detected recommended k value, a situation of a cell, or a Node B, to which the UE currently belongs, and a situation of neighbor cells Step 203. A process of determining the k value is identical to the k value determination process described in conjunction with the first embodiment of the present invention.

After determining the k value, the CRNC transmits the determined k value to a Node B through an NBAP message of a Radio Link Reconfiguration Prepare message in Step 204. Upon receiving the Radio Link Reconfiguration Prepare message, in Step 205, the Node B detects a k value included in the received Radio Link Reconfiguration Prepare message, updates the previously set k value into the detected k value, and then transmits to the CRNC a Radio Link Reconfiguration Ready message, a response message for the Radio Link Reconfiguration Prepare message. Between the Radio Link Setup Request message and Radio Link Setup Response message described in steps 104 and 105 of FIG. 2 and the Radio Link Reconfiguration Prepare message and Radio Link Reconfiguration Ready message described in steps 204 and 205, there exist not only a difference related to radio link setup and radio link reconfiguration but also the following differences.

First, a time when radio link setup-related information including the k value is applied becomes a time when the Radio Link Setup Request message described in step 104 is received. Second, the Radio Link Setup Response message described in step 105 indicates that radio link setup-related information including the k value was successfully applied. Third, the Radio Link Reconfiguration Prepare message described in step 204 indicates radio link reconfiguration-related information including a k value but does not indicate a time when the radio link reconfiguration-related information including the k value is actually applied. Fourth, the Radio Link Reconfiguration Ready message described in step 205 indicates that radio link reconfiguration-related information including the k value was received and that the Node B is ready to apply the received radio link reconfiguration-related information.

Upon receiving the Radio Link Reconfiguration Ready message from the Node B, the CRNC transmits the determined k value to the SRNC through an RNSAP message of a Radio Link Reconfiguration Ready message in Step 206. Upon receiving the Radio Link Reconfiguration Ready message, the SRNC detects a k value included in the Radio Link Reconfiguration Ready message and determines a time to apply the detected k value. Herein, the time to apply the k value is referred to as “activation time.” The SRNC determines the activation time in accordance with Equation (3), which will be described later. After determining the activation time, the SRNC transmits the determined activation time to the CRNC through an RNSAP message of a Radio Link Reconfiguration Commit message in Step 207. Upon receiving the Radio Link Reconfiguration Commit message from the SRNC, the CRNC detects an activation time included in the received Radio Link Reconfiguration Commit message and transmits the detected activation time to the Node B through an NBAP message of a Radio Link Reconfiguration Commit message in Step 208.

Upon receiving the Radio Link Reconfiguration Commit message from the CRNC, the Node B detects an activation time included in the received Radio Link Reconfiguration Commit message and applies the k value at the detected activation time. Meanwhile, after transmitting the Radio Link Reconfiguration Commit message to the CRNC, the SRNC transmits the k value and the activation time to the UE through an RRC message of a Radio Bearer Reconfiguration message in Step 209. Upon receiving the Radio Bearer Reconfiguration message, the UE detects the k value and the activation time from the received Radio Bearer Reconfiguration message and applies the k value at the detected activation time. Thereafter, the UE transmits to the SRNC a Radio Bearer Reconfiguration Complete message as a response message for the Radio Bearer Reconfiguration message in Step 210.

In FIG. 3, the Node B and the UE apply the newly determined k value at an activation time, and the activation time is calculated by

Activation Time=T_Node B_{—}K+T_{—}UE_{—}k+margin Equation (3)

In Equation (3), T_Node B_K indicates a time required in transmitting a k value to a Node B. That is, T_Node B_K indicates a time required when an RNSAP message of a Radio Link Reconfiguration Commit message and an NBAP message of a Radio Link Reconfiguration Commit message are transmitted to the CRNC and the Node B. In addition, T_UE_k represents a time required when the UE and the SRNC exchange a Radio Bearer Reconfiguration message and a Radio Bearer Reconfiguration Complete message. Furthermore, “margin” is a value considered to correct a change in the T_Node B_K+T_UE_k value. Equation (3) above is a mere theoretical formula for calculating the activation time. In an actual radio channel environment, a system can previously determine a particular value considering a structure of Iur/Iub interfaces, for future use.

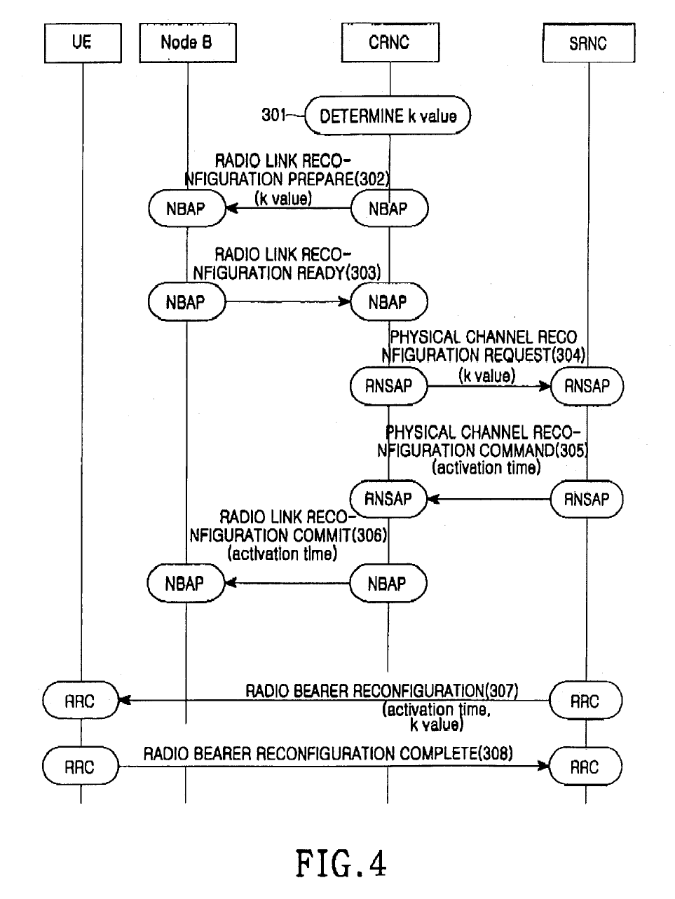

With reference to FIG. 3, a process of determining a CQI report cycle according to the second embodiment of the present invention has been described. Next, a process of determining a CQI report cycle according to a third embodiment of the present invention will be described with reference to FIG. 4.

FIG. 4 is a flow diagram illustrating a process of determining a CQI report cycle according to a third embodiment of the present invention. Referring to FIG. 4, a CRNC determines a k value to be applied to a particular UE in Step 301. In the third embodiment, it is assumed that a new k value is determined in a state where a k value has already been set. A process of determining the k value is similar to the process described in conjunction with FIGS. 2 and 3, so a detailed description thereof will be omitted. After determining the k value, the CRNC transmits the determined k value to a Node B through an NBAP message of a Radio Link Reconfiguration Prepare message in Step 302. Upon receiving the Radio Link Reconfiguration Prepare message, the Node B detects a k value included in the received Radio Link Reconfiguration Prepare message, prepares to apply the detected k value, and transmits to the CRNC a Radio Link Reconfiguration Ready message, a response message for the Radio Link Reconfiguration Prepare message in Step 303. Upon receiving the Radio Link Reconfiguration Ready message, the CRNC transmits the determined k value to an SRNC through an RNSAP message of a Physical Channel Reconfiguration Request message in Step 304. Herein, a new IE of “new CQI report cycle k” is added to the Physical Channel Reconfiguration Request message, and the determined k value is included in the new IE.

Upon receiving the Physical Channel Reconfiguration Request message, the SRNC detects a k value included in the received Physical Channel Reconfiguration Request message and determines an activation time when the detected k value is to be applied. A process of determining the activation time is similar to the activation time determination process described in conjunction with FIG. 3, so a detailed description thereof will be omitted. The SRNC transmits the determined activation time to the CRNC through a Physical Channel Reconfiguration Command message in Step 305. Upon receiving the Physical Channel Reconfiguration Command message, the CRNC detects an activation time included in the received Physical Channel Reconfiguration Command message and transmits the detected activation time to the Node B through a Radio Link Reconfiguration Commit message in Step 306.

After transmitting the Physical Channel Reconfiguration Command message to the CRNC, the SRNC transmits the k value received from the CRNC and the activation time determined itself to the UE through an RRC message of a Radio Bearer Reconfiguration message in Step 307. Upon receiving the Radio Bearer Reconfiguration message, the UE detects a k value and an activation time included in the received Radio Bearer Reconfiguration message and applies the detected k value beginning at the activation time. Thereafter, the UE transmits a Radio Bearer Reconfiguration Complete message to the SRNC in response to the Radio Bearer Reconfiguration message in Step 308.

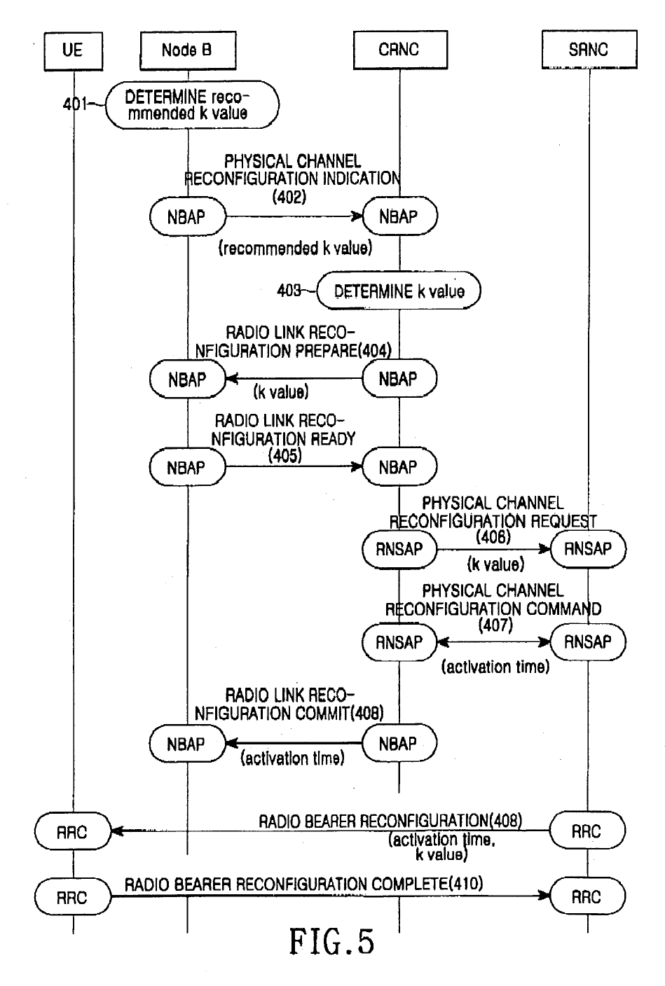

A process of determining a CQI report cycle according to the third embodiment of the present invention has been described with reference to FIG. 4. Next, a process of determining a CQI report cycle according to a fourth embodiment of the present invention will be described with reference to FIG. 5.

FIG. 5 is a flow diagram illustrating a process of determining a CQI report cycle according to a fourth embodiment of the present invention. Referring to FIG. 5, a Node B determines a recommended k value in order to change a k value in Step 401. The Node B changes the current k value to a new k value if it is determined that CQI reliability of a particular UE was decreased lower than a predetermined threshold. That is, since reliability of a CQI report by the UE was decreased, the Node B is required to reduce the CQI report cycle in order to recover reliability above the predetermined threshold. A method for determining the recommended k value by the Node B will be described later. The Node B transmits the determined recommended k value to a CRNC through an NBAP message of a Physical Channel Reconfiguration Indication message in Step 402. Upon receiving the Physical Channel Reconfiguration Indication message, the CRNC detects a recommended k value included in the received Physical Channel Reconfiguration Indication message and determines a k value with the detected recommended k value. A process of determining the k value is identical to the process described above, so a detailed description thereof will not be provided.

Thereafter, the CRNC, SRNC, Node B, and UE perform steps 404 to 410. The processes of steps 404 to 410 are identical in operation to the processes of steps 302 to 308, so a detailed description thereof will be omitted.

A process of determining a CQI report cycle according to the fourth embodiment of the present invention has been described with reference to FIG. 5. All of the first to fourth embodiments stated above provide a process of determining an optimal CQI report cycle, specifically, a process of determining a k value, or a final CQI report cycle, by the CRNC. However, in fifth and sixth embodiments below, a process of determining an optimal k value, or a final CQI report cycle, is performed by an SRNC.

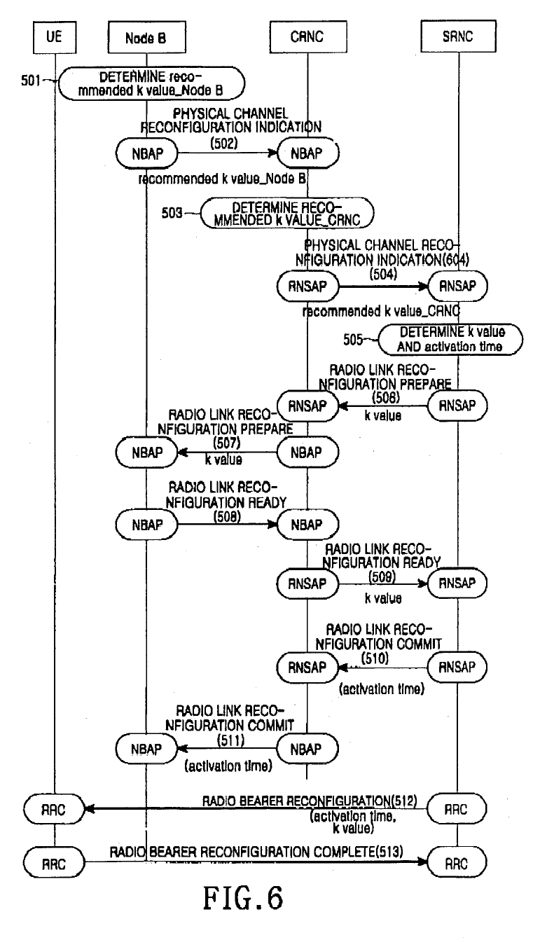

A process of determining a CQI report cycle according to a fifth embodiment of the present invention will now be described with reference to FIG. 6.

FIG. 6 is a flow diagram illustrating a process of determining a CQI report cycle according to a fifth embodiment of the present invention. Referring to FIG. 6, if it is determined that there is a necessary to change a k value for a particular UE, a Node B determines a desired recommended k value_Node B to be used in changing the k value in Step 501. The recommended k value_Node B is a recommended k value generated in a Node B. A process of generating the recommended k value_Node B is identical to the process described in conjunction with Step 401 of FIG. 5.

The Node B delivers the determined recommended k value_Node B to a CRNC through an NBAP message of a Physical Channel Reconfiguration Indication message in Step 502. Upon receiving the Physical Channel Reconfiguration Indication message, the CRNC detects the recommended k value_Node B included in the received Physical Channel Reconfiguration Indication message and determines a recommended k value_CRNC with the detected recommended k value_Node B in Step 503. The recommended k value_CRNC is a recommended k value generated in a CRNC. A process of determining the recommended k value_CRNC is identical to the k value determination process described in conjunction with the first embodiment except that the k value generated in the k value determination process is used as recommended k value_CRNC. In the fifth embodiment, a recommended k value list may be created using output values of the k value determination process. If an output value of the k value determination process is defined as “x,” a recommended k value list becomes

Recommended_{—}k_value_list=[all_{—}k_values|k_value≧x] Equation (4)

The CRNC transmits the determined recommended k value_CRNC to an SRNC through an RNSAP message of a Physical Channel Reconfiguration Indication message in Step 504. The CRNC can transmit either the determined recommended k value_CRNC or the recommended k value list to the SRNC.

Upon receiving the Physical Channel Reconfiguration Indication message, the SRNC detects the recommended k value_CRNC or recommended k value list from the received Physical Channel Reconfiguration Indication message, and determines a k value with the detected recommended k value_CRNC or recommended k value list in Step 505. When determining the k value with the recommended k value_CRNC, the SRNC determines a k value higher than or equal to the recommended k value_CRNC. When determining the k value with the recommended k value list, the SRNC determines a k value equal to a value for a corresponding radio channel condition among the values in the recommended k value list. The SRNC transmits the determined k value to the CRNC through a Radio Link Reconfiguration Prepare message in Step 506. Upon receiving the Radio Link Reconfiguration Prepare message, the CRNC detects a k value included in the received Radio Link Reconfiguration Prepare message and transmits the detected k value to the Node B through a Radio Link Reconfiguration Prepare message in Step 507. Upon receiving the Radio Link Reconfiguration Prepare message, the Node B detects a k value included in the received Radio Link Reconfiguration Prepare message and prepares to apply the detected k value. Thereafter, the Node B transmits a Radio Link Reconfiguration Ready message to the CRNC in response to the Radio Link Reconfiguration Prepare message in Step 508.

Upon receiving the Radio Link Reconfiguration Ready message, the CRNC transmits the k value to the SRNC through a Radio Link Reconfiguration Ready message in response to the Radio Link Reconfiguration Prepare message in Step 509. Upon receiving the Radio Link Reconfiguration Ready message, the SRNC detects a k value included in the received Radio Link Reconfiguration Ready message and determines an activation time at which the detected k value is to be actually applied. A process of determining the activation time is identical to the process described above, so a detailed description thereof will not be provided again.

The SRNC transmits the determined activation time to the CRNC through a Radio Link Reconfiguration Commit message in Step 510. Upon receiving the Radio Link Reconfiguration Commit message, the CRNC detects an activation time included in the received Radio Link Reconfiguration Commit message. Thereafter, the CRNC transmits the detected activation time to the Node B along with a Radio Link Reconfiguration Commit message in Step 511. Upon receiving the Radio Link Reconfiguration Commit message, the Node B detects an activation time included in the received Radio Link Reconfiguration Commit message and applies the k value at the detected activation time.

Meanwhile, after transmitting the Radio Link Reconfiguration Commit message to the CRNC, the SRNC transmits the determined activation time to the UE through a Radio Bearer Reconfiguration message in Step 512. Upon receiving the Radio Bearer Reconfiguration message, the UE detects an activation time included in the received Radio Barer Reconfiguration message and applies the k value at the detected activation time. Thereafter, the UE transmits a Radio Bearer Reconfiguration Complete message to the SRNC as a response message for the Radio Bearer Reconfiguration message in Step 513.

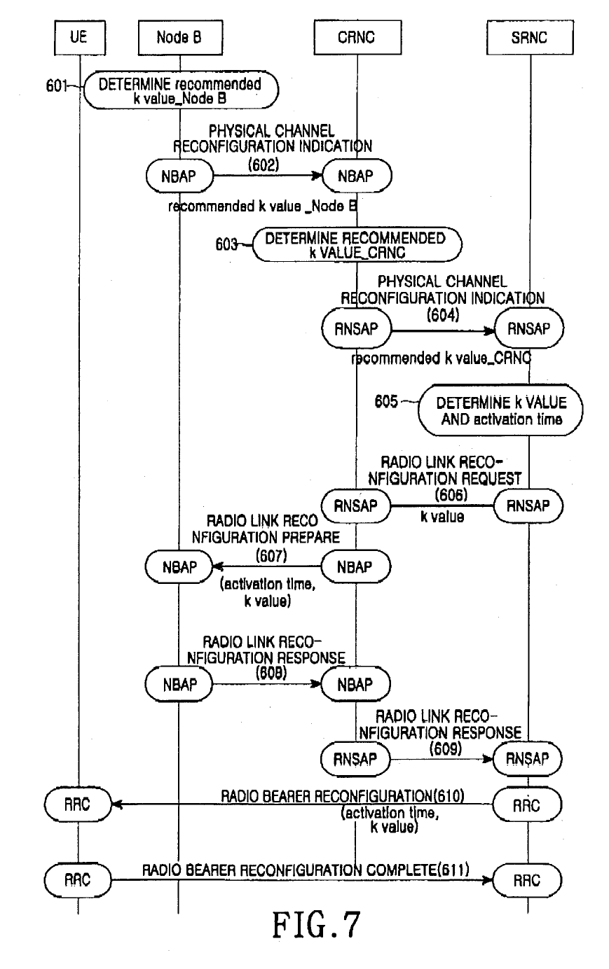

With reference to FIG. 6, a process of determining a CQI report cycle according to the fifth embodiment of the present invention has been described. Next, a process of determining a CQI report cycle according to a sixth embodiment of the present invention will be described with reference to FIG. 7.

FIG. 7 is a flow diagram illustrating a process of determining a CQI report cycle according to a sixth embodiment of the present invention. Referring to FIG. 7, if it is determined that it is necessary to change a k value for a particular UE, a Node B determines a desired recommended k value_Node B for the k value in Step 601. The Node B delivers the determined recommended k value_Node B to a CRNC through an NBAP message of a Physical Channel Reconfiguration Indication message in Step 602. Upon receiving the Physical Channel Reconfiguration Indication message, the CRNC detects recommended k value_Node B included in the received Physical Channel Reconfiguration Indication message and determines a recommended k value_CRNC with the detected recommended k value_Node B in Step 603. Like in the fifth embodiment, the sixth embodiment may also create a recommended k value list using output values of the k value determination process. The CRNC transmits the determined recommended k value_CRNC to an SRNC through an RNSAP message of a Physical Channel Reconfiguration Indication message in Step 604. The CRNC can transmit either the determined recommended k value_CRNC or the recommended k value list to the SRNC.

Upon receiving the Physical Channel Reconfiguration Indication message transmitted by the CRNC, the SRNC detects the recommended k value_CRNC or recommended k value list from the received Physical Channel Reconfiguration Indication message, and determines a k value and an activation time with the detected recommended k value_CRNC or recommended k value list in Step 605. The SRNC transmits the determined k value and activation time to the CRNC through a Radio Link Reconfiguration Request message in Step 606. Upon receiving the Radio Link Reconfiguration Request message, the CRNC detects a k value and an activation time included in the received Radio Link Reconfiguration Request message and transmits the detected k value and activation time to the Node B through a Radio Link Reconfiguration Request message in Step 607. Upon receiving the Radio Link Reconfiguration Request message from the CRNC, the Node B detects a k value and an activation time included in the received Radio Link Reconfiguration Request message, applies the k value at the detected activation time, and then transmits a Radio Link Reconfiguration Response message to the CRNC as a response message for the Radio Link Reconfiguration Request message in Step 608.

Upon receiving the Radio Link Reconfiguration Response message transmitted by the Node B, the CRNC transmits a Radio Link Reconfiguration Response message to the SRNC as a response message for the Radio Link Reconfiguration Request message in Step 609. Upon receiving the Radio Link Reconfiguration Response message from the CRNC, the SRNC transmits the determined k value and activation time to the UE through a Radio Bearer Reconfiguration message in Step 610. Upon receiving the Radio Bearer Reconfiguration message transmitted by the SRNC, the UE detects a k value and an activation time included in the received Radio Bearer Reconfiguration message and applies the k value at the detected activation time. Thereafter, the UE transmits a Radio Bearer Reconfiguration Complete message to the SRNC as a response message for the Radio Bearer Reconfiguration message in Step 611. In FIG. 7, the SRNC performs Step 610 after Steps 607 to 609 are sequentially performed after Step 606. However, as described above, the SRNC actually independently performs Step 610 after performing Step 606.

A description will now be made of a method for determining a recommended k value for generating the k value described above, or the CQI report cycle. As described in the embodiments, in order to enable an SRNC or a CRNC to determine an optimal CQI report cycle, a Node B fundamentally recommends an RNC an appropriate optimal CQI report cycle by the name of a recommended k value, using information the Node B recognizes. The information recognized by the Node B, as described above, includes the number of UEs receiving an HSDPA service among UEs belonging to its current cell, information on a CQI report cycle, or a k value, for each of the UEs, and information on a change in channel condition of the UEs. In this way, the Node B recommends a CQI report cycle, which it considers is most appropriate, by using the information the Node B knows. A method for determining a recommended CQI report cycle by the Node B will be described later. The embodiments described above have proposed a method of determining a final CQI report cycle by a CRNC or an SRNC, using a recommended CQI report cycle of a Node B. If, however, the Node B determines a CQI report cycle, the method of determining a recommended CQI report cycle of the Node B can be used.

A detailed description will now be made of a criterion for determining a recommended k value by a Node B and information recognized by the Node B.

A Node B determines a transport format considering a channel condition of a downlink when transmitting packet data over a downlink. That is, if a downlink has a relatively good channel condition, the Node B transmits a large amount of information data by using a high-level modulation scheme such as 16-QAM and a channel coding scheme having a high coding rate of R=3/4. However, if the downlink has a poor channel condition, the Node B transmits a relatively small amount of information data as compared with when the downlink has a good channel condition, by using a low-level modulation scheme such as QPSK and a channel coding scheme having a low coding rate of R=1/6. As described above, the Node B adaptively determines a transport format according to a downlink channel condition and transmits packet data according to the determined transport format, thereby decreasing a reception error rate. That is, when the Node B selects a transport format without considering a downlink channel condition, a reception error rate of transmission packet data is increased.

The Node B measures a channel condition of the downlink from CQI reported by a UE. In addition, when the UE is in a non-handover state, the Node B can estimate the downlink channel condition even with transmission power of a downlink dedicated physical channel (DL DPCH) of which power control is performed in a closed-loop power control method. That is, if the downlink dedicated physical channel has relatively high transmission power, the Node B determines that the downlink channel condition is poor. In contrast, if the downlink dedicated physical channel has relatively low transmission power, the Node B determines that the downlink channel condition is excellent. When the CQI report cycle, or a k value, has a value larger than 1, i.e., when the UE is in a non-handover state, the Node B estimates a downlink channel condition with transmission power of the downlink dedicated physical channel. Because transmission power of the downlink dedicated physical channel is considered during CQI report, if transmission power of the downlink dedicated physical channel is high, a CQI report cycle, or a k value, reported by the UE is increased, thereby minimizing uplink interference.

In addition, the k value is variably determined according to a location of a UE and a variation rate of a downlink channel condition. More specifically, when a UE is located in a handover region, i.e., when the UE is in a handover state, the UE receives downlink dedicated physical channel signals from a plurality of Node Bs existing in an active set. Thereafter, the UE generates a Transmit Power Control (TPC) command for downlink power control by soft-combining the downlink dedicated physical channel signals received from the Node Bs, so transmission power of the downlink dedicated physical channel cannot accurately reflect a channel condition of a downlink for a cell that is actually providing an HSDPA service. Therefore, when the UE is located in a handover region, a k value, or a CQI report cycle, must be smaller than when the UE is located in a non-handover region. In addition, if a channel condition of the downlink is varied relatively frequently, a k value, or a CQI report cycle, must be decreased in order to accurately estimate a variation rate of the channel condition.

When a k value, or a CQI report cycle, is not adaptively determined according to a downlink channel condition in the above-described manner, the Node B cannot accurately estimate a downlink channel condition. Therefore, a reception error rate is increased during packet data transmission, resulting in an increase in occurrence of a reception error for transmission packet data. An occurrence frequency of the reception error can be determined with the number of acknowledgement (ACK) information or negative acknowledgement (NACK) information that a UE transmits to the Node B each time it receives packet data. The ACK information indicates normal receipt of packet data, while the NACK information represents a failure to normally receive packet data, i.e., abnormal receipt of the packet data. That is, the Node B determines whether a k value, or a CQI report cycle, is appropriately set, based on the reception error occurrence frequency of the packet data. If the k value is not appropriately set, the Node B adjusts the k value or the CQI report cycle.

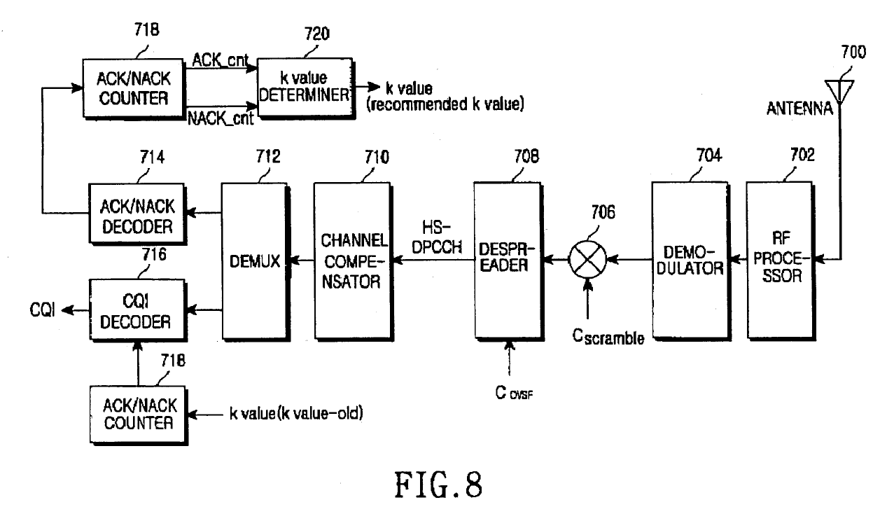

With reference to FIG. 8, a description will now be made of a method for determining a recommended k value, or a recommended CQI report cycle, by a Node B based on a reception error occurrence frequency of packet data, i.e., an occurrence frequency of ACK information or NAKC information stated above.

FIG. 8 is a block diagram illustrating an internal structure of a Node B apparatus for determining a recommended CQI report cycle according to ACK/NACK.

Referring to FIG. 8, an RF (Radio Frequency) signal transmitted from a UE is received at the Node B through an antenna 700, and the antenna 700 provides the received RF signal to an RF processor 702. The RF processor 702 converts the RF signal output from the antenna 700 into a baseband signal and provides the baseband signal to a demodulator 704. The demodulator 704 demodulates an output signal of the RF processor 702 by a modulation scheme corresponding to a modulation scheme applied in the UE, and provides its output to a multiplier 706. The multiplier 706 multiplies an output signal of the demodulator 704 by a predetermined scrambling code C_{scramble} and provides its output to a despreader 708. Herein, the multiplier 706 serves as a descrambler. The despreader 708 multiplies an output signal of the multiplier 706 by a predetermined channelization code COVSF, for despreading, and provides its output to a channel compensator 710. The signal multiplied by the channelization code COVSF by the despreader 708 is output as a high speed dedicated physical control channel (HS-DPCCH) signal. The channel compensator 710 channel-compensates the HS-DPCCH signal output from the despreader 708 and provides its output to a demultiplexer (DEMUX) 712.

The DEMUX 712 demultiplexes the output signal of the channel compensator 710 into ACK/NACK and CQI in accordance with a slot format of the HS-DPCH, and provides the ACK/NACK to an ACK/NACK decoder 714 and the CQI to a CQI decoder 716. The ACK/NACK decoder 714 decodes an output signal of the DEMUX 712 into ACK or NACK and provides the ACK or NACK to an ACK/NACK counter 718. The ACK/NACK counter 718 counts the number of ACKs or NACKs received from the ACK/NACK decoder 714 and outputs ACK_cnt and NACK_cnt. The ACK_cnt indicates a value determined by counting the number of ACKs, and the NACK_cnt indicates a value determined by counting the number of NACKs. The ACK_cnt and the NACK_cnt are provided to a k value determiner 720, and the k value determiner 720 determines a recommended k value with the ACK_cnt and the NACK_cnt output from the ACK/NACK counter 718. Here, the k value determined by the k value determiner 720 becomes the recommended k value described above. Meanwhile, the CQI decoder 716 decodes an output signal of the demultiplexer 712 into CQI. A CQI decoder controller 722 controls decoding of the CQI according to a currently set k value. That is, the CQI decoder controller 722 controls the CQI decoder 716 to decode CQI every k frames corresponding to the set k value.

A description will now be made of a detailed process of determining the recommended k value by the k value determiner 720.

The k value determiner 720 calculates an occurrence rate of ACK, using ACK_cnt and the NACK_cnt output from the ACK/NACK counter 718. The occurrence rate of ACK is determined as “ACK_cnt/(ACK_cnt+NACK_cnt)” for a predetermined period. When the calculated ACK occurrence rate is lower than a predetermined ACK occurrence rate, it indicates that estimation of a downlink channel condition is not accurately performed. Thus, in this case, the k value, or the CQI report cycle, must be decreased. That is, if the ACK occurrence rate is lower than the predetermined ACK occurrence rate, it indicates that a channel condition is poor. Thus, the CQI report cycle must be reduced to frequently receive a CQI report and then reflect the channel condition. In contrast, if the ACK occurrence rate is higher than or equal to the predetermined ACK occurrence rate, it indicates that estimation of the downlink channel condition is relatively accurately performed. Thus, in this case, the k value or the CQI report cycle, can be increased. That is, since the channel condition is excellent, it is permissible to receive a CQI report at intervals by increasing the CQI report cycle. By doing so, uplink interference is reduced.

Criteria for determining a new k value, i.e., a recommended k value, by comparing the ACK occurrence rate with the predetermined ACK occurrence rate in order to adjust the k value or the CQI report cycle are as follows.

If 0.0<ACK_cnt/(ACK_cnt+NACK_cnt)≦0.2, then recommended k value=C1*k value_old.

If 0.2<ACK_cnt/(ACK_cnt+NACK_cnt)≦0.4, then recommended k value=C2*k value_old.

If 0.4<ACK_cnt/(ACK_cnt+NACK_{—acnt)≦}0.6, then recommended k value=C3*k value_old.

If 0.6<ACK_cnt/(ACK_cnt+NACK_cnt)≦0.8, then recommended k value=C4*k value_old.

If 0.8<ACK_cnt/(ACK_cnt+NACK_cnt)≦1.0, then recommended k value=C5*k value_old.

In the foregoing description, “k value_old” is a k value currently set in the Node B, and C1 to C5 represent constants for adjusting the k value_old value. For example, C1=0.25, C2=0.5, C3=1, C4=2, and C5=4.

That is, in order to set an appropriate CQI report cycle, or k value, according to a variation rate of the downlink channel condition without excessively increasing uplink interference, the Node B sets the k value to a small value if the channel condition is varied frequently as stated above. However, if the channel condition is varied relatively infrequently, the Node B sets the k value to a large value. It is possible to estimate a variation rate of a channel condition by determining a Doppler frequency using a pilot signal of an uplink dedicated physical control channel (UL DPCCH) or an HS-DPCCH signal received from a UE. That is, if the Doppler frequency is high, it indicates that the channel condition is varied relatively frequently. However, if the Doppler frequency is low, it indicates that the channel condition is varied relatively infrequently.

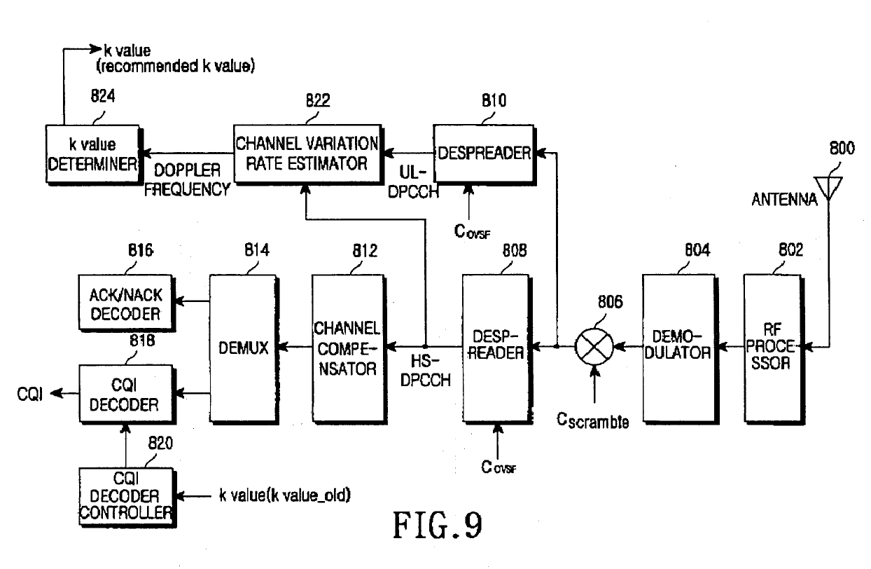

A method for determining a k value or a recommended CQI report cycle according to a channel condition variation rate by a Node B will now be described with reference to FIG. 9.

FIG. 9 is a block diagram illustrating an internal structure of a Node B apparatus for determining a recommended CQI report cycle according to a channel condition variation rate. Referring to FIG. 9, an RF signal transmitted from a UE is received at the Node B through an antenna 800, and the antenna 800 provides the received RF signal to an RF processor 802. The RF processor 802 converts the RF signal output from the antenna 800 into a baseband signal and provides the baseband signal to a demodulator 804. The demodulator 804 demodulates an output signal of the RF processor 802 by a modulation scheme corresponding to a modulation scheme applied in the UE, and provides its output to a multiplier 806. The multiplier 806 multiplies an output signal of the demodulator 804 by a predetermined scrambling code Cscramble and provides its output to a despreader 808 and a despreader 810. Herein, the multiplier 806 serves as a descrambler. The despreader 808 multiplies an output signal of the multiplier 806 by a predetermined channelization code COVSF, for despreading, and provides its output to a channel compensator 812. The signal multiplied by the channelization code COVSF by the despreader 808 is output as an HS-DPCCH signal. The channel compensator 812 channel-compensates the HS-DPCCH signal output from the despreader 808 and provides its output to a DEMUX 814.

The DEMUX 814 demultiplexes an output signal of the channel compensator 812 into ACK/NACK and CQI in accordance with a slot format of the HS-DPCH, and provides the ACK/NACK to an ACK/NACK decoder 816 and the CQI to a CQI decoder 818. The ACK/NACK decoder 816 decodes an output signal of the DEMUX 814 into ACK or NACK. The CQI decoder 818 decodes an output signal of the DEMUX 814 into CQI. A CQI decoder controller 820 controls decoding of the CQI according to a currently set k value. That is, the CQI decoder controller 820 controls the CQI decoder 818 to decode CQI every k frames corresponding to the set k value.

In addition, the despreader 810 multiplies an output signal of the multiplier 806 by a predetermined channelization code COVSF, for despreading, and provides its output to a channel variation rate estimator 822. The signal multiplied by the channelization code COVSF by the despreader 810 is output as a UL_DPCCH signal. The channel variation rate estimator 822 calculates a Doppler frequency by receiving a pilot signal of the UL_DPCCH signal or an HS-DPCCH signal output from the despreader 808, and estimates a channel variation rate with the calculated Doppler frequency. The channel variation rate estimator 822 provides the Doppler frequency to a k value determiner 824 for determining a recommended k value. The k value determiner 824 determines a new k value with the Doppler frequency, or a channel condition variation rate, output from the channel variation rate estimator 822. Here, the new k value becomes the recommended k value described above.

A description will now be made of a detailed process of determining a k value by the k value determiner 824.

If the Doppler frequency output from the channel variation rate estimator 822 is high, it indicates that the channel condition varies frequently. Thus, in this case, the k value determiner 824 sets a recommended k value to a small value. However, if the Doppler frequency is low, it indicates that the channel condition varies infrequently. In this case, the k value determiner 824 sets the recommended k value to a large value. That is, the recommended k value is determined according to the Doppler frequency, as follows.

If 0<Doppler frequency≦50 Hz, then recommended k value=10

If 50 Hz<Doppler frequency≦100 Hz, then recommended k value=5

If 100 Hz<Doppler frequency, then recommended k value=1

In the foregoing description, the Node B does not use a previously set k value, i.e., k value_old, in determining a recommended k value. However, it is also possible to determine a recommended k value by using the k value_old, and this will be described below.

If the Doppler frequency is higher than a previous Doppler frequency, it indicates that a channel condition variation rate is high. Thus, in this case, the k value determiner 824 decreases a recommended k value below the k value_old. In contrast, if the Doppler frequency is lower than a previous Doppler frequency, it indicates that a channel condition variation rate is low. In this case, the k value determiner 824 increases the recommended k value above the k value_old. If a newly estimated Doppler frequency is defined as “New_doppler freq,” and a previously estimated Doppler frequency is defined as “Old_doppler_freq,” the k value determiner 824 determines a recommended k value according to a ratio “New_doppler_freq/Old_doppler_freq” of the New_doppler freq to the Old_doppler freq, as follows.

If New Doppler_freq/Old_doppler freq≦0.5, then recommended k value=C1*k value_old

If 0.5<New_Doppler_freq/Old_Doppler_freq≦1.5, then recommended k value=C2*k value_old

If 1.5<New_Doppler_freq/Old_Doppler_freq, then recommended k value=C3*k value_old

In the foregoing description, “k value_old” is a k value currently set in the Node B, and C1 to C3 represents constants for adjusting the k value_old value. For example, C1=2, C2=1 and C3=0.5.

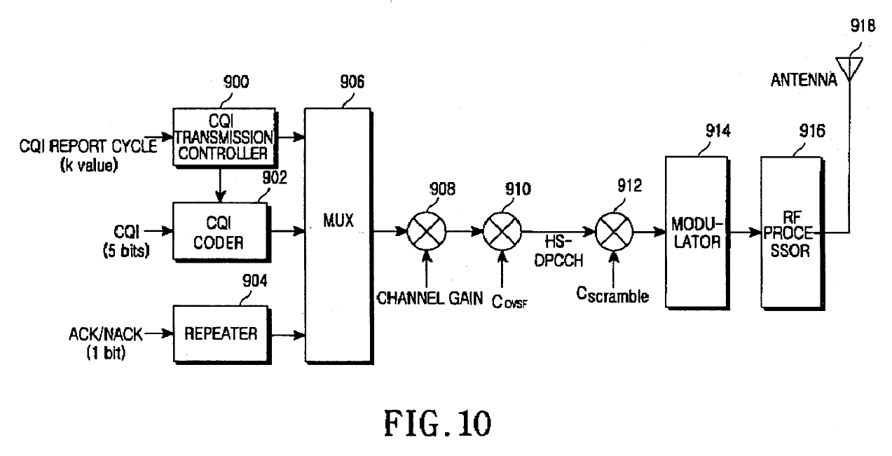

The recommended k value determined in the Node B is delivered to an SRNC or a CRNC through the processes described in conjunction with FIGS. 2 to 7, and the SRNC or CRNC then determines an optimal k value or CQI report cycle. The determined optimal k value or CQI report cycle is delivered to the Node B and a UE. As described above, activation time information is also delivered together. The Node B and the UE then operate synchronized with the activation time. The Node B prepares to receive a CQI report provided at the determined CQI report cycle, and the UE starts sending a CQI report to the Node B at the determined CQI report cycle. A process of performing a CQI report according to the determined k value by a UE will now be described in detail with reference to FIG. 10.

FIG. 10 is a block diagram illustrating an internal structure of a UE for performing a CQI report according to embodiments of the present invention. Referring to FIG. 10, a CQI transmission controller 900 controls a CQI coder 902 to generate CQI according to the k value, i.e., by the k frames, the k value being provided from the CRNC or SRNC, and also controls a multiplexer (MUX) 906 to multiplex the CQI generated by the CQI coder 902 according to the k value. The CQI transmission controller 900 controls transmission of the CQI, using the activation time information provided from the SRNC or CRNC. A repeater 904 repeatedly provides 1-bit ANC/NACK to the MUX 906. The MUX 906 multiplexes output signals of the CQI coder 902 and the repeater 904 in accordance with a slot format of the HS-DPCCH and provides its output to a multiplier 908. The multiplier 908 multiplies an output signal of the MUX 906 by a predetermined channel gain and provides its output to a multiplier 910. The multiplier 910 multiplies an output signal of the multiplier 908 by a predetermined channelization code COVSF, for spreading, and provides its output to a multiplier 912. Here, the multiplier 910 serves as a spreader. An HS-DPCCH signal output from the multiplier 910 is applied to the multiplier 912, and the multiplier 912 multiplies an output signal of the multiplier 910 by a predetermined scrambling code C_{scramble}, for scrambling, and provides its output to a modulator 914. Herein, the multiplier 912 serves as a scrambler. The modulator 914 modulates an output signal of the multiplier 912 by a predetermined modulation scheme and provides its output to an RF processor 916. The RF processor 916 converts an output signal of the modulator 914 into an RF signal and transmits the RF signal over the air via an antenna 918.

As described above, in an HSDPA communication system, the present invention determines an optimal CQI report cycle needed to report channel quality by using information recognized by communication entities actually proving an HSDPA service, i.e., such communication entities as an SRNC, a CRNC, a Node B and a UE. In addition, the present invention determines a CQI report cycle considering a plurality of parameters such as a radio channel environment and a resource amount, thereby contributing to improvement in system performance.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An apparatus for determining channel quality indicator (CQI) report cycles for user equipments (UEs), upon receiving CQI information from the UEs receiving a high speed downlink packet access (HSDPA) service from a Node B, in a mobile communication system including the Node B and a plurality of the UEs existing in a cell region occupied by the Node B, the apparatus comprising:
a receiver for receiving from each of the UEs acknowledgement (ACK) information or negative acknowledgement (NACK) information indicating whether received data is defective; and
a recommended CQI report cycle determiner for calculating an ACK information occurrence rate by counting a number of the ACK information or the NACK information detected for each of the UEs for a predetermined period, comparing the ACK information occurrence rate with a predetermined ACK information occurrence rate, and determining recommended CQI report cycles for the UEs according to the comparison result.

2. The apparatus of claim 1, wherein the recommended CQI report cycle determiner sets the recommended CQI report cycles to be shorter than predetermined recommended CQI report cycles, if the ACK information occurrence rate is lower than the predetermined ACK information occurrence rate.

3. The apparatus of claim 1, wherein the recommended CQI report cycle determiner sets the recommended CQI report cycles to be longer than predetermined recommended CQI report cycles, if the ACK information occurrence rate is higher than or equal to the predetermined ACK information occurrence rate.

4. The apparatus of claim 1, wherein the ACK information and the NACK information are received over a high speed dedicated physical control channel (HS-DPCCH).

5. An apparatus for determining channel quality indicator (CQI) report cycles for user equipments (UEs) upon receiving CQI information from the UEs receiving a high speed downlink packet access (HSDPA) service from a Node B, in a mobile communication system including the Node B and a plurality of the UEs existing in a cell region occupied by the Node B, the apparatus comprising:
a receiver for receiving a particular channel signal and detecting a current channel condition variation rate by using the received particular channel signal; and
a recommended CQI report cycle determiner for comparing the current channel condition variation rate with a predetermined channel condition variation rate, and determining a recommended CQI report cycle according to the comparison result.

6. The apparatus of claim 5, wherein the a recommended CQI report cycle determiner compares the current channel condition variation rate with a previous channel condition variation rate, and the determines the recommended CQI report cycle according to the comparison result.

7. The apparatus of claim 5, wherein the recommended CQI report cycle determiner sets the recommended CQI report cycle to be shorter than a predetermined CQI report cycle, if the current channel condition variation rate exceeds the predetermined channel condition variation rate.

8. The apparatus of claim 7, wherein the channel condition variation rate is determined with a Doppler frequency of the particular channel signal.

9. The apparatus of claim 6, wherein the recommended CQI report cycle determiner sets the recommended CQI report cycles to be shorter than predetermined CQI report cycles, if the current channel condition variation rate exceeds the previous channel condition variation rate.

10. The apparatus of claim 9, wherein the channel condition variation rate is determined with a Doppler frequency of the particular channel signal.

11. A method for determining channel quality indicator (CQI) report cycles for user equipments (UEs) upon receiving CQI information from the UEs receiving a high speed downlink packet access (HSDPA) service from a Node B, in a mobile communication system including the Node B and a plurality of the UEs existing in a cell region occupied by the Node B, the method comprising the steps of:
receiving from each of the UEs acknowledgement (ACK) information or negative acknowledgement (NACK) information indicating whether received data is defective; and
calculating an ACK information occurrence rate by counting the number of the ACK information and NACK information detected for each of the UEs for a predetermined period, comparing the ACK information occurrence rate with a predetermined ACK information occurrence rate, and determining recommended CQI report cycles for the UEs according to the comparison result.

12. The method of claim 11, wherein the recommended CQI report cycle determination step comprises the step of setting the recommended CQI report cycle to be shorter than a predetermined recommended CQI report cycle, if the ACK information occurrence rate is lower than the predetermined ACK information occurrence rate.

13. The method of claim 11, wherein the recommended CQI report cycle determination step comprises the step of setting the recommended CQI report cycles to be longer than predetermined recommended CQI report cycles, if the ACK information occurrence rate is higher than or equal to the predetermined ACK information occurrence rate.

14. The method of claim 11, wherein the ACK information and the NACK information is received over a high speed dedicated physical control channel (HSDPCCH).

15. A method for determining channel quality indicator (CQI) report cycles for user equipments (UEs), upon receiving CQI information from the UEs receiving a high speed downlink packet access (HSDPA) service from a Node B, in a mobile communication system including the Node B and a plurality of the UEs existing in a cell region occupied by the Node B, the method comprising the steps of:
receiving a particular channel signal and detecting a current channel condition variation rate by using the received particular channel signal; and
comparing the current channel condition variation rate with a predetermined channel condition variation rate, and then determining a recommended CQI report cycle according to the comparison result.

16. The method of claim 15, wherein the recommended CQI report cycle determining step comprises the step of comparing the current channel condition variation rate with a previous channel condition variation rate, and then determining the recommended CQI report cycle according to the comparison result.

17. The method of claim 15, wherein the recommended CQI report cycle determination step comprises the step of setting the recommended CQI report cycle to be shorter than a predetermined CQI report cycle, if the current channel condition variation rate exceeds the predetermined channel condition variation rate.

18. The method of claim 17, wherein the channel condition variation rate is determined with a Doppler frequency of the particular channel signal.

19. The method of claim 16, wherein the recommended CQI report cycle determination step comprises the step of setting the recommended CQI report cycle to be shorter than a predetermined CQI report cycle, if the current channel condition variation rate exceeds the previous channel condition variation rate.

20. The method of claim 19, wherein the channel condition variation rate is determined with a Doppler frequency of the particular channel signal.

21. A method for determining channel quality indicator (CQI) report cycles for user equipments (UEs) upon receiving CQI information from the UEs receiving a high speed downlink packet access (HSDPA) service from a Node B, in a mobile communication system including the Node B, a plurality of the UEs existing in a cell region occupied by the Node B, a controlling radio network controller (CRNC) connected to the Node B, and a serving radio network controller (SRNC) connected to the CRNC, the method comprising the steps of:
(a) determining, by the SRNC, recommended CQI report cycles based on whether the UEs are in a handover state, and transmitting the determined recommended CQI report cycles to the CRNC;
(b) determining, by the CRNC, CQI report cycles of the UEs by considering the recommended CQI report cycles, a state of Node Bs currently communicating with the UEs, and a state of their neighbor Node Bs, and transmitting the determined CQI report cycles to the SRNC and the Node Bs; and
(c) transmitting, by the SRNC, the determined CQI report cycles to the UEs.

22. The method of claim 21, wherein the step (a) comprises the step of determining the recommended CQI report cycles according to the number of radio links set up by the UEs.

23. The method of claim 21, wherein the step (b) comprises the step of determining the recommended CQI report cycles considering a maximum resource amount supportable by the Node Bs.

24. A method for determining channel quality indicator (CQI) report cycles for user equipments (UEs), upon receiving CQI information from the UEs receiving a high speed downlink packet access (HSDPA) service from a Node B, in a mobile communication system including the Node B, a plurality of the UEs existing in a cell region occupied by the Node B, a controlling radio network controller (CRNC) connected to the Node B, and a serving radio network controller (SRNC) connected to the CRNC, the method comprising the steps of:
(a) if it is determined that current CQI report cycles set for the UEs should be changed, determining, by the SRNC, desired CQI report cycles as recommended CQI report cycles and transmitting the determined recommended CQI report cycles to the CRNC;
(b) determining, by the CRNC, CQI report cycles of the UEs by considering the recommended CQI report cycles, a state of Node Bs currently communicating with the UEs, and a state of their neighbor Node Bs, and then transmitting the determined CQI report cycles to the Node Bs; and
(c) determining, by the SRNC, an activation time indicating a time when the determined CQI report cycles are to be applied, transmitting the activation time and the determined CQI report cycles to the Node Bs via the CRNC, and transmitting the activation time and the determined CQI report cycles to the UEs.

25. The method of claim 24, wherein the step (b) comprises the step of determining the CQI report cycles considering a maximum resource amount supportable by the Node Bs.

26. The method of claim 24, wherein the step (c) comprises the step of determining the activation time considering a time required in transmitting the determined CQI report cycles to the Node Bs and the UEs.

27. A method for determining channel quality indicator (CQI) report cycles for user equipments (UEs), upon receiving CQI information from the UEs receiving a high speed downlink packet access (HSDPA) service from a Node B, in a mobile communication system including the Node B, a plurality of the UEs existing in a cell region occupied by the Node B, a controlling radio network controller (CRNC) connected to the Node B, and a serving radio network controller (SRNC) connected to the CRNC, the method comprising the steps of:
(a) if it is determined that current CQI report cycles set for the UEs should be changed, determining, by the CRNC, desired CQI report cycles as new CQI report cycles considering a state of Node Bs currently communicating with the UEs and a state of their neighbor Node Bs, and transmitting the determined new CQI report cycles to the Node Bs and the SRNC; and
(b) upon receiving the new CQI report cycles, determining by the SRNC an activation time indicating a time when the determined new CQI report cycles are to be applied, transmitting the activation time to the Node Bs, and transmitting the activation time and the determined new CQI report cycles to the UEs.

28. The method of claim 27, wherein the step (a) comprises the step of determining the new CQI report cycles considering a maximum resource amount supportable by the Node Bs.

29. The method of claim 27, wherein the step (b) comprises the step of determining the activation time considering a time required in transmitting the new CQI report cycles to the Node Bs and the UEs.

30. A method for determining channel quality indicator (CQI) report cycles for user equipments (UEs) upon receiving CQI information from the UEs receiving a high speed downlink packet access (HSDPA) service from a Node B, in a mobile communication system including the Node B, a plurality of the UEs existing in a cell region occupied by the Node B, a controlling radio network controller (CRNC) connected to the Node B, and a serving radio network controller (SRNC) connected to the CRNC, the method comprising the steps of:
(a) determining, by the Node B, recommended CQI report cycles based on the number of UEs and the CQI information, and transmitting the recommended CQI report cycles to the CRNC;
(b) determining, by the CRNC, new CQI report cycles considering the recommended CQI report cycles and states of the Node B and its neighbor Node Bs, and transmitting the determined new CQI report cycles to the Node B and the SRNC; and
(c) upon receiving the new CQI report cycles, determining, by the SRNC, an activation time indicating a time when the determined new CQI report cycles are to be actually applied, transmitting the determined activation time to the Node B, and transmitting the activation time and the new CQI report cycles to the UEs.

31. The method of claim 30, wherein the step (b) comprises the step of determining the new CQI report cycles considering a maximum resource amount supportable by the Node B.

32. The method of claim 31, wherein the step (c) comprises the step of determining the activation time considering a time required in transmitting the new CQI report cycles to the Node B and the UEs.

33. A method for determining channel quality indicator (CQI) report cycles for user equipments (UEs), upon receiving CQI information from the UEs receiving a high speed downlink packet access (HSDPA) service from a Node B, in a mobile communication system including the Node B, a plurality of the UEs existing in a cell region occupied by the Node B, a controlling radio network controller (CRNC) connected to the Node B, and a serving radio network controller (SRNC) connected to the CRNC, the method comprising the steps of:
(a) if it is determined that current CQI report cycles set for the UEs should be changed, determining, by the Node B, first recommended CQI report cycles, and transmitting the first recommended CQI report cycles to the CRNC;
(b) determining, by the CRNC, second recommended CQI report cycles considering the first recommended CQI report cycles and states of the Node B and its neighbor Node Bs, and transmitting the second recommended CQI report cycles to the SRNC; and
(c) determining, by the SRNC, CQI report cycles for the second recommended CQI report cycles and an activation time indicating a time when the determined CQI report cycles are to be actually applied, and transmitting the determined CQI report cycles and the activation time to the Node B and the UEs.

34. The method of claim 33, wherein the step (b) comprises the step of determining the second recommended CQI report cycles considering a maximum resource amount supportable by the Node B.

35. The method of claim 33, wherein the step (c) comprises the step of determining the activation time considering a time required in transmitting the determined CQI report cycles to the Node B and the UEs.

36. A method for determining channel quality indicator (CQI) report cycles for user equipments (UEs), upon receiving CQI information from the UEs receiving a high speed downlink packet access (HSDPA) service from a Node B, in a mobile communication system including the Node B, a plurality of the UEs existing in a cell region occupied by the Node B, a controlling radio network controller (CRNC) connected to the Node B, and a serving radio network controller (SRNC) connected to the CRNC, the method comprising the steps of:
(a) determining, by the Node B, recommended CQI report cycles based on the number of UEs and the CQI information;
(b) transmitting, by the Node B, the recommended CQI report cycles to the SRNC via the CRNC; and
(c) transmitting, by the SRNC, CQI report cycles determined for the recommended CQI report cycles to the UEs and the Node B.

37. The method of claim 36, wherein the step (a) comprises the step (d) determining the recommended CQI report cycles according to acknowledgement (ACK) information or negative acknowledgement (NACK) information indicating whether data received from the UEs is defective.

38. The method of claim 37, wherein the step (d) comprises the step of calculating an ACK information occurrence rate by counting the number of the ACK information and the NACK information detected for a predetermined period, comparing the ACK information occurrence rate with a predetermined ACK information occurrence rate, and determining the recommended CQI report cycles according to the comparison result.

39. The method of claim 36, wherein the step (a) comprises the step of detecting a current channel condition variation rate, comparing the current channel condition variation rate with a predetermined channel condition variation rate, and determining the recommended CQI report cycles according to the comparison result.

40. An apparatus for determining channel quality indicator (CQI) report cycles for user equipments (UEs), upon receiving CQI information from the UEs receiving a high speed downlink packet access (HSDPA) service from a Node B, in a mobile communication system including the Node B, a plurality of the UEs existing in a cell region occupied by the Node B, a controlling radio network controller (CRNC) connected to the Node B, and a serving radio network controller (SRNC) connected to the CRNC, the apparatus comprising:
the Node B for determining recommended CQI report cycles based on the number of UEs and the CQI information, and transmitting the determined recommended CQI report cycles to the SRNC via the CRNC; and
the SRNC for determining CQI report cycles for the UEs referring to the recommended CQI report cycles, and transmitting the determined CQI report cycles to the UEs and the Node B.

41. The apparatus of claim 40, wherein the Node B determines the recommended CQI report cycles according to acknowledgement (ACK) information or negative acknowledgement (NACK) information indicating whether data received from the UEs is defective.

42. The apparatus of claim 41, wherein the Node B calculates an ACK information occurrence rate by counting the number of the ACK information and the NACK information detected for a predetermined period, compares the ACK information occurrence rate with a predetermined ACK information occurrence rate, and determines the recommended CQI report cycles according to the comparison result.

43. The apparatus of claim 40, wherein the Node B compares a current channel condition variation rate with a predetermined channel condition variation rate, and determines the recommended CQI report cycles according to the comparison result.

44. A method for determining channel quality indicator (CQI) report cycles for user equipments (UEs), upon receiving CQI information from the UEs receiving a high speed downlink packet access (HSDPA) service from a Node B, in a mobile communication system including the Node B, a plurality of the UEs existing in a cell region occupied by the Node B, a controlling radio network controller (CRNC) connected to the Node B, and a serving radio network controller (SRNC) connected to the CRNC, the method comprising the steps of:
determining, by the Node B, recommended CQI report cycles desired to be applied to the UEs;
transmitting, by the Node B, the recommended CQI report cycles to the SRNC via the CRNC; and
determining, by the SRNC, CQI report cycles for the UEs referring to the recommended CQI report cycles and transmitting the determined CQI report cycles to the UEs and the Node B.

45. An apparatus for determining channel quality indicator (CQI) report cycles for user equipments (UEs), upon receiving CQI information from the UEs receiving a high speed downlink packet access (HSDPA) service from a Node B, in a mobile communication system including the Node B, a plurality of the UEs existing in a cell region occupied by the Node B, a controlling radio network controller (CRNC) connected to the Node B, and a serving radio network controller (SRNC) connected to the CRNC, the apparatus comprising:
the Node B for determining recommended CQI report cycles desired to be applied to the UEs, and transmitting the recommended CQI report cycles to the SRNC via the CRNC; and
the SRNC for determining CQI report cycles for the UEs referring to the recommended CQI report cycles, and transmitting the determined CQI report cycles to the UEs and the Node B.
